(19) United States
(12) Patent Application Publication
(10) Pub. No.: US 2022/0332416 A1
(43) Pub. Date: Oct. 20, 2022

(54) MOBILE BODY, MOBILE BODY CONTROL METHOD, MOBILE BODY CONTROL PROGRAM, MANAGEMENT DEVICE, MANAGEMENT CONTROL METHOD, MANAGEMENT CONTROL PROGRAM, AND MOBILE BODY SYSTEM

(71) Applicant: SONY GROUP CORPORATION, TOKYO (JP)

(72) Inventors: DAI KOBAYASHI, TOKYO (JP); TATSUYA ISHIZUKA, TOKYO (JP)

(21) Appl. No.: 17/754,263

(22) PCT Filed: Aug. 7, 2020
(86) PCT No.: PCT/JP2020/030498

§ 371 Date: Mar. 29, 2022

(30) Foreign Application Priority Data
Oct. 7, 2019 (JP) 2019-184816

(51) Int. Cl. B64C 39/02; G08G 5/00; G05D 1/10

(52) U.S. Cl. CPC B64C 39/024; G08G 5/0069; G05D 1/104; G05D 1/1064; B64C 2201/122

(57) ABSTRACT

A mobile body (200) includes a generation unit (264), a first communication unit (220), a second communication unit (230), an acquisition unit (265), a providing unit (266), and an integration unit (267). A generation unit (264) generates map information. The first communication unit (220) communicates with a management device (100). The second communication unit (230) communicates with other mobile body using a communication band different from a communication band used by the first communication unit (220). The acquisition unit (265) acquires first map information generated in other mobile body through communication by the second communication unit (230). The providing unit (266) provides second map information to other mobile body through communication by the second communication unit (230). The integration unit (267) integrates the first map information and the second map information to generate integrated map information.

### FIELD

The present disclosure relates to a mobile body, a mobile body control method, a mobile body control program, a management device, a management control method, a management control program, and a mobile body system.

### BACKGROUND

Various technologies for providing information necessary for automatic driving and driving support regarding autonomous movement of automobiles, robots, unmanned x vehicles (UXVs), and the like have been developed.

### CITATION LIST

### Patent Literature

Patent Literature 1: JP 2007-137139 A
Patent Literature 2: JP 2004-118730 A

### Non Patent Literature

Non Patent Literature 1: “What is a map “dynamic map” required for automatic driving? KDDI, Zenrin and Fujitsu have started demonstration experiment of distribution technology”, [online], [searched on Jul. 30, 2019], Internet <URL:https://internet.watch.impress.co.jp/docs/column/chizu3/1106525.html>

### SUMMARY

### Technical Problem

An unmanned aerial vehicle represented by a drone, an autonomously movable robot, and the like are always required to realize safe and efficient autonomous movement.

Therefore, the present disclosure proposes a mobile body, a mobile body control method, a mobile body control program, a management device, a management control method, a management control program, and a mobile body system capable of realizing safe and efficient autonomous movement.

### Solution to Problem

To solve the above problem, a mobile body that moves autonomously that provides a service that requires an identity verification process according to an embodiment of the present disclosure includes: a generation unit that generates map information; a first communication unit that communicates with a management device; a second communication unit that communicates with other mobile body using a communication band different from a communication band used by the first communication unit; an acquisition unit that acquires first map information generated in other mobile body through communication by the second communication unit; a providing unit that provides second map information generated by the generation unit to other mobile body through communication by the second communication unit; and an integration unit that integrates the first map information and the second map information to generate integrated map information.

### BRIEF DESCRIPTION OF DRAWINGS

FIG. 1 is a diagram illustrating a configuration example of a mobile body system according to an embodiment.

FIG. 2 is a diagram illustrating an outline of the mobile body system according to the embodiment.

FIG. 3 is a diagram illustrating an example of a functional configuration of a management device according to the embodiment.

FIG. 4 is a diagram illustrating an outline of position information according to the embodiment.

FIG. 5 is a diagram illustrating an example of a functional configuration of a mobile body according to the embodiment.

FIG. 6 is a diagram illustrating an outline of map information according to the embodiment.

FIG. 7 is a diagram illustrating an outline of processing by an integration unit according to the embodiment.

FIG. 8 is a flowchart illustrating an example of a processing procedure of the management device according to the embodiment.

FIG. 9 is a flowchart illustrating an example of a processing procedure of a mobile body according to the embodiment.

FIG. 10 is a flowchart illustrating an example of a processing procedure of the mobile body according to the embodiment.

FIG. 11 is a diagram illustrating a first modified example of an integration method of map information.

FIG. 12 is a diagram illustrating an example of a functional configuration of a mobile body according to a modified example.

FIG. 13 is a diagram illustrating a second modified example of the integration method of the map information.

FIG. 14 is a diagram illustrating an example of a functional configuration of a management device according to a modified example.

FIG. 15 is a diagram illustrating an outline of high-speed communicable range information according to a modified example.

FIG. 16 is a diagram illustrating an example of a platoon of mobile bodies according to a modified example.

FIG. 17 is a diagram illustrating an example of a functional configuration of a management device according to a modified example.

FIG. 18 is a diagram illustrating an outline of high-speed communicable range information according to a modified example.

FIG. 19 is a diagram illustrating an example of a platoon of mobile bodies according to a modified example.

FIG. 20 is a diagram illustrating an example of a functional configuration of a management device according to a modified example.

FIG. 21 is a diagram illustrating an outline of equipment information according to a modified example.

FIG. 22 is a diagram illustrating an example of a platoon of mobile bodies according to a modified example.

FIG. 23 is a sequence diagram illustrating an example of processing of a mobile body system according to a modified example.

FIG. 24 is a diagram illustrating a configuration example of a mobile body system according to a modified example.

FIG. 25 is a diagram illustrating an example of a functional configuration of a management device according to a modified example.

FIG. 26 is a diagram illustrating an outline of base station information according to a modified example.

FIG. 27 is a diagram illustrating an example of a functional configuration of a base station device according to a modified example.

FIG. 28 is a diagram illustrating an outline of mobile body information according to a modified example.

FIG. 29 is a diagram illustrating an example of a functional configuration of a mobile body according to a modified example.

FIG. 30 is a hardware configuration diagram illustrating an example of a computer that realizes functions of the management device according to the embodiment.

FIG. 31 is a hardware configuration diagram illustrating an example of a computer that implements functions of the mobile body according to the embodiment.

### DESCRIPTION OF EMBODIMENTS

Hereinafter, embodiments of the present disclosure will be described in detail with reference to the drawings. Note that, in each of the following embodiments, the same parts are denoted by the same reference signs, and redundant description will be omitted.

In addition, in the following embodiments, a plurality of constituent elements having substantially the same functional configuration may be distinguished and described by attaching different numerals after the same reference numerals. For example, a plurality of configurations having substantially the same functional configuration such as a first mobile body 200₁ and a second mobile body 200₂ are distinguished as necessary. Further, in a case where it is not necessary to particularly distinguish each of a plurality of components having substantially the same functional configuration, for example, only the same reference numerals are given as in a mobile body 200, and description will be given without particular distinction.

An embodiment of the present disclosure can be applied to an unmanned x vehicle (UXV), a robot, an industrial device, a vehicle, and the like which include a sensing device (sensor) and a computer resource, and can operate autonomously or according to an instruction while performing data processing. Hereinafter, a case where the mobile body according to the embodiment of the present disclosure is an unmanned aerial vehicle (UAV) such as a drone will be described.

The present disclosure will be described according to the following order of items shown below.

1. Overview

2. Configuration of device

3. Processing procedure

4. Modified example of method of integrating map information

5. Modified example of method of specifying mobile body group

6. Modified example of method of instructing exchange of map information

7. Compensation processing by management device

8. Modified example of mobile body system

9. Hardware configuration

10. Conclusion

### 1. Overview

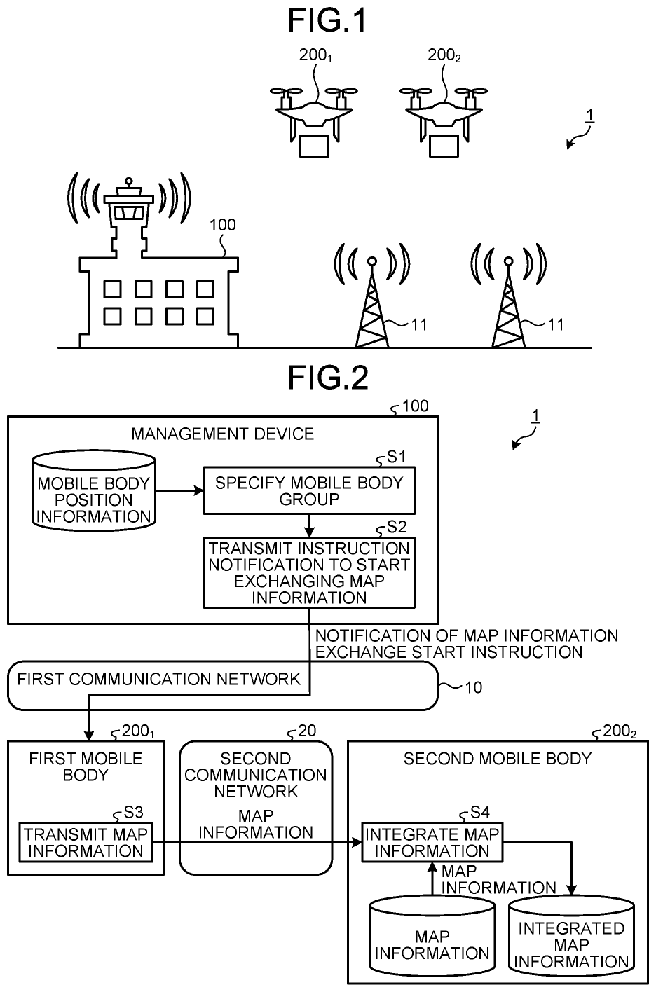

An outline of a mobile body system 1 according to an embodiment will be described with reference to FIGS. 1 and 2. FIG. 1 is a diagram illustrating a configuration example of the mobile body system according to the embodiment. FIG. 2 is a diagram illustrating an outline of the mobile body system according to the embodiment.

As illustrated in FIG. 1, the mobile body system 1 includes a management device 100 and a plurality of mobile bodies 200.

The management device 100 transmits an instruction related to flight to the plurality of mobile bodies 200 via a base station 11 by public radio communication. The mobile body 200 receives the instruction related to flight from the management device 100 via the base station 11, and autonomously flies according to the received instruction. Note that a flight control form of the mobile body system 1 can adopt various forms, and the mobile body 200 may transmit a request related to flight to the management device 100, and the management device 100 may perform flight control of the mobile body 200 in a form of approving the request from the mobile body 200.

When autonomously flying according to an instruction of the management device 100, the mobile body 200 generates map information in which positions of surrounding obstacles are recorded on the basis of a detection result of a sensing device or the like, and performs operation control so as to avoid collision with an obstacle or the like using the generated map information.

Here, there may be a blind spot region that cannot be detected in the mobile body 200. Therefore, in order to avoid collision with an obstacle hidden in the blind spot region, for example, it is conceivable to use map information that complements the blind spot region such as map information generated by another mobile body 200. However, as the map information becomes wider, a data size also becomes larger. For this reason, in the low-speed public radio communication via the management device 100, it is difficult to transmit and receive the map information between the mobile bodies 200 in real time and exchange the map information.

Therefore, in view of such a problem, the present disclosure proposes the mobile body system 1 that realizes safe and efficient autonomous movement based on the map information.

As illustrated in FIG. 2, the management device 100 specifies a plurality of mobile bodies 200 located in a range in which direct communication is possible between the mobile bodies 200 as a mobile body group using mobile body position information (Step S1). Then, the management device 100 transmits a notification instructing the specified mobile body group to start exchanging the map information via a first communication network 10 (Step S2). The first communication network 10 is a public wireless communication network including a cellular communication network, a wireless communication network compatible with long-distance wireless for the mobile body 200, or the like.

Upon receiving the notification instructing the start of the exchange of the map information from the management device 100, a first mobile body 200₁ transmits the map information generated by the first mobile body 200₁ to the second mobile body 200₂ via a second communication network 20 (Step S3). The second communication network 20 is a network capable of high-speed communication, and examples thereof include a wireless communication network compatible with WiFi (registered trademark) and a wireless communication network network compatible with visible light laser communication.

Upon receiving the map information from the first mobile body 200₁, a second mobile body 200₂ integrates the map information of the first mobile body 200₁ and the map information generated by the second mobile body 200₂ (Step S4), and generates integrated map information.

As described above, in the mobile body system 1 according to the embodiment, the mobile body 200 can exchange the map information in real time by transmitting and receiving the high-speed wireless communication, and generate the integrated map complementing the blind spot region. Therefore, according to the mobile body system 1 according to the embodiment, safe and efficient autonomous movement by the mobile body 200 can be realized.

### 2. Configuration of Device

(2-1. Management Device)

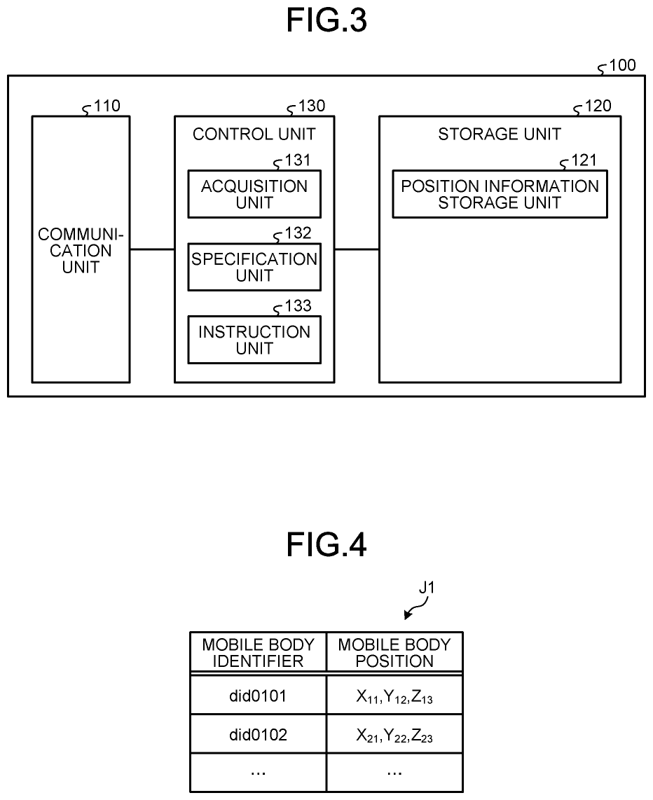

A functional configuration of the management device 100 according to the embodiment will be described with reference to FIG. 3. FIG. 3 is a diagram illustrating an example of a functional configuration of the management device according to the embodiment.

As illustrated in FIG. 3, the management device 100 includes a communication unit 110, a storage unit 120, and a control unit 130.

The communication unit 110 communicates with the mobile body 200 via the first communication network 10. The communication unit 110 receives position information of the mobile body 200. The communication unit 110 transmits a notification instructing the mobile body 200 to start exchanging map information.

Note that the communication unit 110 supports various communication schemes for communicating with the mobile body 200 via the first communication network 10. The communication scheme supported by the communication unit 110 includes, for example, a communication scheme compatible with a cellular communication system, and a communication scheme compatible with a public wireless network such as long-distance wireless for mobile bodies. The cellular communication system includes a fourth generation mobile communication system (4G, 4GLTE), a fifth generation mobile communication system (5G), and the like. For example, a frequency band of 920 MHz is used in Japan in a communication scheme compatible with long-distance wireless for mobile bodies.

The storage unit 120 stores programs, data, and the like used for processing by the control unit 130. The storage unit 120 includes a position information storage unit 121.

FIG. 4 is a diagram illustrating an outline of position information according to the embodiment; As illustrated in FIG. 4, position information J1 stored in the position information storage unit 121 includes an item of a mobile body identifier and an item of a mobile body position, and these items are associated with each other. In the item of the mobile body position, for example, X, Y, and Z coordinates are stored, but information of latitude, longitude and altitude may be stored.

The control unit 130 integrally controls processing of the management device 100. As illustrated in FIG. 3, the control unit 130 includes an acquisition unit 131, a specification unit 132, and an instruction unit 133.

The acquisition unit 131 acquires the position information J1 of the mobile body 200 stored in the position information storage unit 121.

Based on the position information acquired by the acquisition unit 131, the specification unit 132 specifies a plurality of mobile bodies 200 located in a range in which direct communication is possible between the mobile bodies 200 as a mobile body group. Specifically, the specification unit 132 calculates a Euclidean distance between the mobile bodies 200 from a position of the mobile body 200 recorded in the position information J1. Then, the specification unit 132 compares the calculated Euclidean distance between the mobile bodies 200 with a predetermined threshold value, and specifies a combination of the mobile bodies 200 in which the Euclidean distance is less than the threshold value.

For example, when a position of the first mobile body 200₁ is (Xa, Ya, Za), a position of the second mobile body 200₂ is (Xb, Yb, Zb), and the Euclidean distance is “D”, the specification unit 132 specifies a mobile body group satisfying a condition represented by a formula (1) below.

{square root over (((Xa−Xb))\hat{2}+(Ya−Yb)\hat{2}+(Za−Zb)\hat{2})<D)} (1)

The instruction unit 133 instructs the mobile body group specified by the specification unit 132 to exchange the map information. For example, the instruction unit 133 transmits a notification for instructing any one of the specified mobile bodies 200 to start exchanging the map information. At that time, the instruction unit 133 includes the mobile body identifier of the mobile body 200, which is a transmission destination of the map information, in the notification. Further, the instruction unit 133 transmits an instruction to start communication to the other mobile body 200. The instruction unit 133 outputs a notification instructing start of exchange of the map information to the communication unit 110, thereby instructing the group of the mobile bodies 200 specified by the specification unit 132 to exchange the map information via the communication unit 110.

Furthermore, the instruction unit 133 instructs the mobile body 200 on an action plan such as a flight route of the mobile body 200.

The specification unit 132 may specify not only the combination of the one-to-one mobile bodies 200 but also the combination of the one-to-many mobile bodies 200 as the mobile body group. In this case, the instruction unit 133 transmits to the plurality of mobile bodies 200 a notification instructing the multicast of the map information to the mobile bodies 200.

(2-2. Mobile Body)

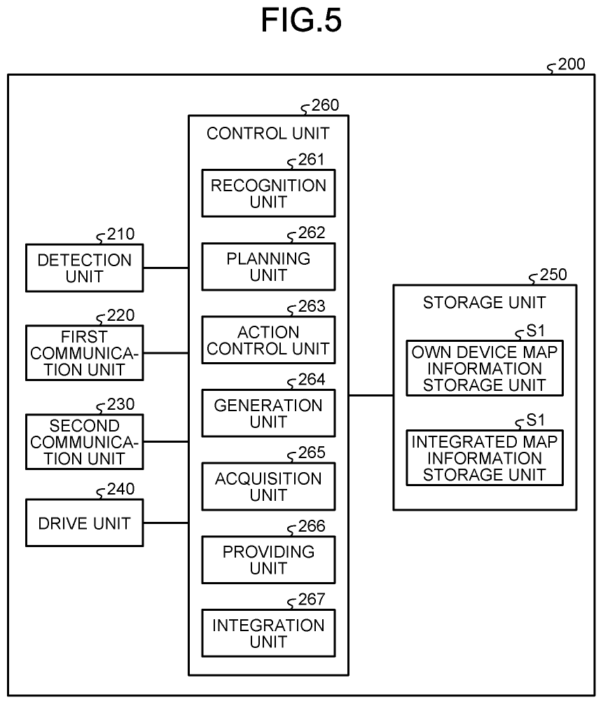

A functional configuration of the mobile body according to the embodiment will be described with reference to FIG. 5. FIG. 5 is a diagram illustrating an example of a functional configuration of the mobile body according to the embodiment. Note that, in the following description, the mobile body 200 may be referred to as “own device” or “other device”.

As illustrated in FIG. 5, the mobile body 200 includes a detection unit 210, a first communication unit 220, a second communication unit 230, a drive unit 240, a storage unit 250, and a control unit 260.

The detection unit 210 includes various sensors and the like that detect sensor information used for processing of the mobile body 200, and supplies detected data to the control unit 260 and the like.

The detection unit 210 can include an imaging device having a camera that captures an image of a peripheral region of the own device. The imaging device may include, for example, a time of flight (ToF) camera, a stereo camera, a monocular camera, an infrared camera, a depth camera, and other cameras.

Furthermore, the detection unit 210 can include a state sensor that detects a state of the own device. The state sensor may include, for example, a gyro sensor, an acceleration sensor, an inertial measurement unit (IMU), a surrounding information detection sensor, a sensor for detecting a motor rotational speed, and the like. In addition, the surrounding information detection sensor can detect an object such as an obstacle around the mobile body 200. The surrounding information detection sensor may include, for example, an ultrasonic sensor, a radar, light detection and ranging or laser imaging detection and ranging (LiDAR), a sonar, or the like.

Furthermore, the detection unit 210 can include various sensors for detecting the current position of the mobile body 200. The detection unit 210 may include, for example, a global positioning system (GPS) receiver, a global navigation satellite system (GNSS) receiver that receives a GNSS signal from a GNSS satellite, and the like. Furthermore, the detection unit 210 may include a microphone that collects sound around the mobile body 200.

The first communication unit 220 communicates with the management device 100 via the first communication network 10. The first communication unit 220 receives a notification instructing start of exchange of the map information from the management device 100.

Note that the first communication unit 220 supports a communication scheme for communicating with the management device 100 via the first communication network 10. The communication scheme supported by the first communication unit 220 includes, for example, a communication scheme compatible with a cellular communication system, and a communication scheme compatible with a public wireless network such as long-distance wireless for mobile bodies. The cellular communication system includes a fourth generation mobile communication system (4G, 4GLTE), a fifth generation mobile communication system (5G), and the like. For example, a frequency band of 920 MHz is used in Japan in a communication scheme compatible with long-distance wireless for mobile bodies. In addition, the first communication unit 220 may support a communication standard for simultaneously transmitting (multicasting) the map information to the plurality of mobile bodies 200 in order to respond to the multicast instruction from the management device 100.

The second communication unit 230 communicates with another mobile body 200 via the second communication network 20 having a communication band different from that of the first communication network 10 used by the first communication unit 220. The second communication network 20 is, for example, a network that has a wider bandwidth for data transmission than the first communication network 10 or has a shorter communication delay (lower latency) and is capable of high-speed communication. The second communication unit 230 executes communication with another mobile body 200 on the basis of an instruction from the management device 100. For example, the second communication unit 230 transmits the map information of the own device to the other mobile body 200 in response to the notification instructing the start of the exchange of the map information received from the management device 100. In addition, the second communication unit 230 receives map information of the other device transmitted from the other mobile body 200.

Note that the second communication unit 230 supports a communication scheme for communicating with another mobile body 200 via the second communication network 20. The communication scheme supported by the second communication unit 230 includes, for example, WiFi (registered trademark) and a communication standard compatible with visible light laser communication.

The drive unit 240 includes various devices related to a drive system of the mobile body 200. The drive unit 240 includes a driving force generator or the like for generating a driving force of a plurality of driving motors or the like, and rotates a rotary blade of the mobile body 200. For example, the drive unit 240 drives the driving motors or the like in accordance with a command from the management device 100, and supplies a driving force to the rotary blade to rotate the rotary blade. As a result, the mobile body 200 floats and flies.

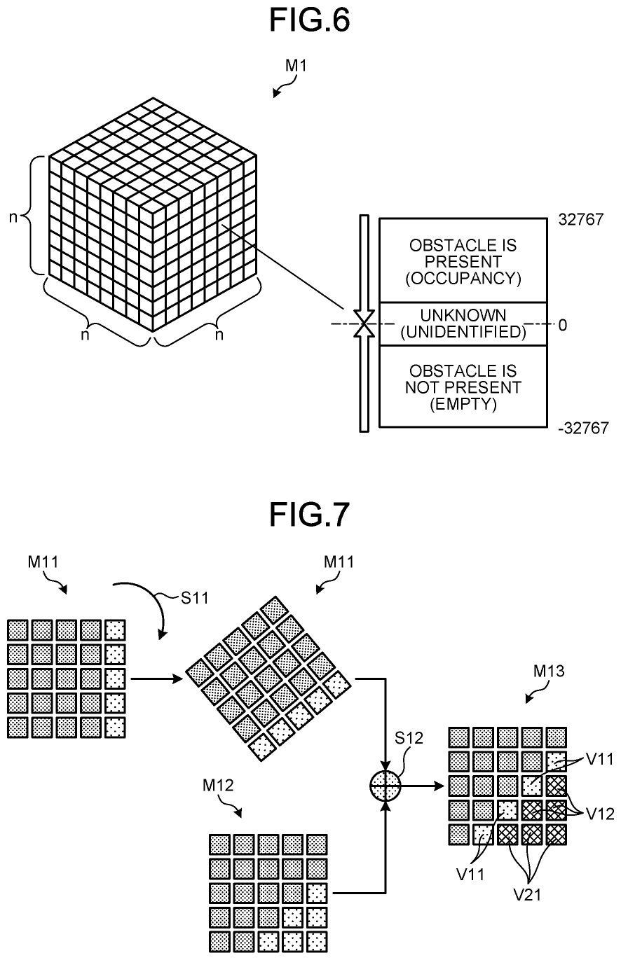

The storage unit 250 stores programs, data, and the like used for processing by the control unit 260. The storage unit 250 includes an own device map information storage unit 251 and an integrated map information storage unit 252. FIG. 6 is a diagram illustrating an outline of the map information according to the embodiment.

As illustrated in FIG. 6, map information M1 stored in the own device map information storage unit 251 and the integrated map information storage unit 252 includes, for example, a three-dimensional voxel map representing a detection result of an obstacle with a three-dimensional (n×n×n) cubic data structure. The map information M1 includes information on relative coordinates indicating where in a global coordinate system a center is, and information on a positional relationship between the center and an obstacle. In addition, the map information M1 is configured by associating a first value, a second value, or a third value with each of unit elements (voxels) constituting the cubic data structure. A value corresponding to a possibility that an obstacle is present is associated with the first value, and for example, a value closer to “32767” is given as the possibility that the obstacle is present is higher. A value corresponding to a possibility that no obstacle is present is associated with the second value, and for example, a value closer to “−32767” is given as the possibility that the obstacle is present is lower. A value corresponding to a possibility that the presence or absence of an obstacle is unknown is associated with the third value, and a value closer to “0” is given as the presence or absence of an obstacle is unknown. The first value, the second value, and the third value can be rephrased as reliability indicating the possibility that an obstacle is present, reliability indicating the possibility that an obstacle is not present, and reliability indicating the possibility that the presence or absence of an obstacle is unknown, respectively.

Furthermore, the map information M1 does not have to be particularly limited in a case where the map information M1 is configured by a three-dimensional voxel map, and may be configured by a three-dimensional point group (point cloud). The three-dimensional point group (point cloud) expresses the detection result of the obstacle by a point cloud set associated with the position information. Even in a case where the map information M1 is configured by the three-dimensional point group (point cloud), the map information M1 has information on relative coordinates indicating where in a global coordinate system a center is, and has information on a positional relationship between the center and an obstacle. In addition, the first value, the second value, or the third value is associated with each of points constituting the three-dimensional point group.

Note that, in the map information M1, each unit element may be associated with an attribute (meaning of an image region) of an obstacle (object) occupying each unit element. The attribute of the object is acquired by performing image recognition of an image used to generate the map information when the map information is generated.

The control unit 260 integrally controls the mobile body 200. The control unit 260 includes a recognition unit 261, a planning unit 262, an action control unit 263, a generation unit 264, an acquisition unit 265, a providing unit 266, and an integration unit 267.

The recognition unit 261 recognizes the presence or absence of an object (obstacle or the like) present around the mobile body 200, a distance to the object (obstacle or the like), and the like on the basis of a detection result of the detection unit 210. Furthermore, the recognition unit 261 recognizes the position, posture, acceleration, angular velocity, and the like of the mobile body 200 on the basis of the detection result of the detection unit 210. The recognition unit 261 supplies a result of the recognition to the planning unit 262.

In accordance with an instruction from the management device 100, the planning unit 262 plans an action of the mobile body 200 on the basis of map information of the own device, integrated map information to be described later, the recognition result of the recognition unit 261, and the like. The planning unit 262 generates a movement trajectory to be a flight plan of the mobile body 200 on the basis of the presence or absence of an object (obstacle or the like), the distance to the object (obstacle or the like), and the position of the mobile body 200 acquired from the recognition unit 261, and map information of the own device, integrated map information to be described later, and the like. The movement trajectory includes, for example, an XYZ point sequence at predetermined intervals (for example, an interval of 0.1 seconds), and a target of a velocity and an angular velocity at each time point. The planning unit 262 supplies the generated movement trajectory to the action control unit 263.

The action control unit 263 controls the flight of the mobile body 200 so as to follow the movement trajectory generated by the planning unit 262. The action control unit 263 generates a control signal for controlling the current flight speed, angular velocity, attitude, propeller rotation speed, and the like of the mobile body 200 so as to cause the mobile body 200 to fly following the movement trajectory, and supplies the control signal to the drive unit 240.

The generation unit 264 generates map information (an example of second map information) of the own device on the basis of the detection result of the detection unit 210. The map information is a set of obstacle information recording a positional relationship between the own device and an obstacle around the mobile body 200 detected by the detection unit 210. The map information generated by the generation unit 264 can be constituted by, for example, a three-dimensional voxel map representing a detection result of an obstacle with a three-dimensional cubic data structure, or a three-dimensional point group (point cloud). The generation unit 264 stores the generated map information in the own device map information storage unit 251.

An example of a method of generating map information by the generation unit 264 will be described. For example, the generation unit 264 generates a texture map by performing bird's-eye view conversion on an image captured by the detection unit 210. Subsequently, the generation unit 264 generates an occupancy grid map (OGM) on the basis of depth data indicating a distance (depth value) to an object (obstacle or the like) detected by the detection unit 210. The OGM includes, for example, an occupied grid having a value (a first value or a second value) corresponding to a possibility of the presence or absence of an obstacle, or a value (a third value) corresponding to a possibility of the presence or absence of an obstacle being unknown. Subsequently, the generation unit 264 generates a semantic map that gives semantics to the OGM. The semantics is an attribute of an object appearing in an image (meaning of an image region), and is acquired by executing semantic segmentation on an image captured by the detection unit 210. The generation unit 264 integrates the texture map and the semantic map, and generates a three-dimensional voxel map representing a set of obstacle information with a three-dimensional cubic data structure or a three-dimensional point group as map information.

The acquisition unit 265 acquires map information (an example of first map information) generated in other mobile body 200 through communication by the second communication unit 230. For example, when receiving a communication start instruction from the management device 100, the acquisition unit 265 connects to the second communication network 20, and waits for reception of the map information of other mobile body 200.

The providing unit 266 provides the map information generated by the generation unit 264 to other mobile body 200 through communication by the second communication unit 230. The providing unit 266 specifies other mobile body 200 communicated by the second communication unit 230 through the communication with the management device 100 by the first communication unit 220, and provides the map information of the own device generated by the generation unit 264 to the specified other mobile body 200. For example, when receiving a notification instructing to start exchange of map information received from the management device 100, the providing unit 266 acquires map information from the own device map information storage unit 251. The providing unit 266 is connected to the second communication network 20, and outputs the map information acquired from the own device map information storage unit 251 to the second communication unit 230 with a mobile body identifier included in the notification from the management device 100 as a destination.

The integration unit 267 integrates the map information of the other device (the other mobile body 200) received by the acquisition unit 265 and the map information of the own device generated by the generation unit 264 to generate integrated map information, and the integration unit 267 stores the generated integrated map information in the integrated map information storage unit 252. FIG. 7 is a diagram illustrating an outline of processing by the integration unit according to the embodiment.

As illustrated in FIG. 7, the integration unit 267 coordinate-transforms map information M11 of the other device acquired from the other device into the same coordinate system as map information M12 of the own device (Step S11). For example, the integration unit 267 converts each of the map information M11 of the other device and the map information M12 of the own device into a global coordinate system.

Then, the integration unit 267 integrates the map information M12 of the own device and the map information M11 of the other device (Step S12) to generate integrated map information M13. When integrating the map information M12 of the own device and the map information M11 of the other device, the integration unit 267 adjusts the first value, the second value, or the third value to make the reliability of the map information of the own device relatively higher than that of the map information of the other device. For example, the integration unit 267 increases the first value associated with a corresponding location V12 of the integrated map information M13 corresponding to a location where an obstacle exists in the map information M12 of the own device to increase the reliability. Alternatively, the integration unit 267 reduces the first value associated with a corresponding location V11 of the integrated map information M13 corresponding to a location where an object exists in the map information M11 of the other device to lower the reliability.

### 3. Processing Procedure

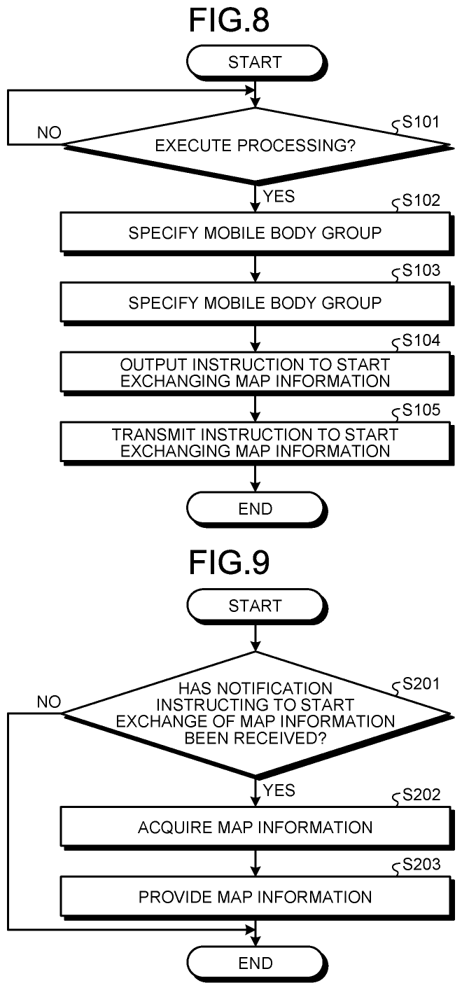

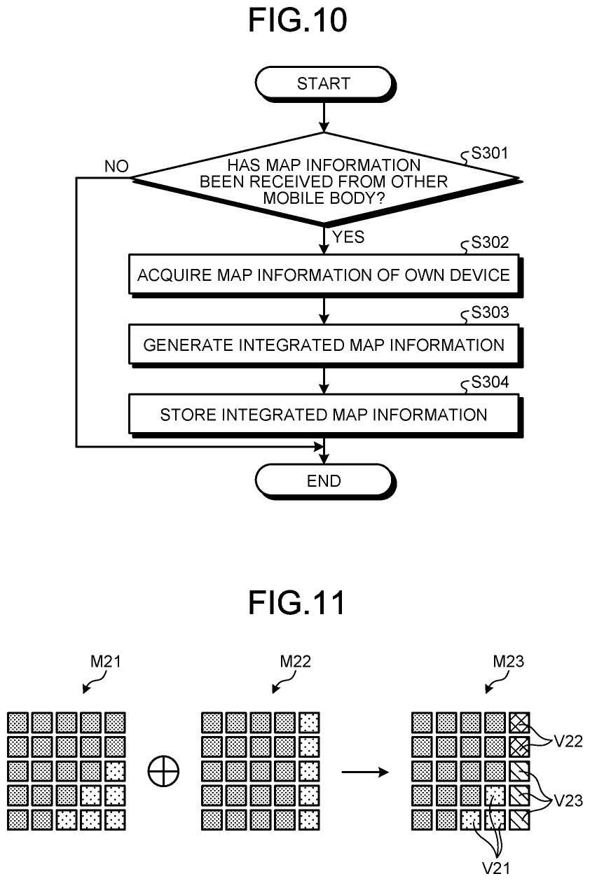

A processing procedure according to the embodiment will be described with reference to FIGS. 8 to 10. FIG. 8 is a flowchart illustrating an example of a processing procedure of the management device according to the embodiment. FIGS. 9 and 10 are flowcharts illustrating an example of a processing procedure of the mobile body according to the embodiment.

(3-1. Processing Procedure of Management Device)

As illustrated in FIG. 8, the acquisition unit 131 determines whether or not to execute processing of instructing exchange of map information (Step S101).

When the acquisition unit 131 determines not to execute the processing of instructing an effect of the map information (Step S101; No), the processing procedure illustrated in FIG. 8 is ended.

When the acquisition unit 131 determines to execute the processing of instructing the effect of the map information (Step S101; Yes), the position information J1 of the mobile body 200 is acquired from the position information storage unit 121 (Step S102).

Subsequently, the specification unit 132 specifies a mobile body group on the basis of the position information J1 of the mobile body 200 (Step S103). That is, the management device 100 specifies a plurality of the mobile bodies 200 located in a range in which direct communication is possible between the mobile bodies 200 as the mobile body group.

Subsequently, the specification unit 132 outputs a notification for instructing the mobile body group to start exchanging the map information to the communication unit 110 (Step S104).

The communication unit 110 transmits the notification for instructing the mobile bodies 200 constituting the mobile body group to start exchanging the map information (Step S105), and ends the processing procedure illustrated in FIG. 8.

(3-2-1. Processing Procedure (1) of Mobile Body)

As illustrated in FIG. 9, the providing unit 266 determines whether or not a notification instructing to start exchange of map information has been received from the management device 100 (Step S201).

When the providing unit 266 determines that the notification instructing to start the exchange of the map information has not been received (Step S201; No), the processing procedure illustrated in FIG. 9 is ended.

When the providing unit 266 determines that the notification instructing to start the exchange of the map information has been received (Step S201; Yes), map information of the own device is acquired from the own device map information storage unit 251 (Step S202).

Subsequently, the providing unit 266 provides the map information of the own device to the other mobile body 200 through the second communication network 20 by communication by the second communication unit 230 (Step S203), and ends the processing illustrated in FIG. 9.

(3-2-2. Processing Procedure (2) of Mobile Body)

As illustrated in FIG. 10, the acquisition unit 265 determines whether or not map information has been received from other mobile body 200 (Step S301).

When the acquisition unit 265 determines that the map information has not been received from other mobile body 200 (Step S301; No), the processing procedure illustrated in FIG. 10 is ended.

When the acquisition unit 265 determines that the map information has been received from other mobile body 200 (Step S301; Yes), the integration unit 267 acquires map information of the own device from the own device map information storage unit 251 (Step S302).

Subsequently, the integration unit 267 integrates the map information received from the other mobile body 200 and the map information of the own device to generate integrated map information (Step S303).

The integration unit 267 stores the integrated map information in the integrated map information storage unit 252 (Step S304), and ends the processing illustrated in FIG. 10.

### 4. Modified Example of Method of Integrating Map Information

(4-1. Prioritize a Map Information of Own Device)

FIG. 11 is a diagram illustrating a first modified example of an integration method of map information. When generating integrated map information M23, the integration unit 267 may give priority to a value (first value, second value, or third value) associated with each unit element of map information M21 of own device.

For example, it is assumed that a location where there is a high possibility that an obstacle exists in the map information M21 of the own device is a location where there is a high possibility that no obstacle exists in map information M22 of other device. In this case, the integration unit 267 prioritizes a value in the map information M21 of the own device, associates a value indicating that there is a high possibility that an obstacle exists with a corresponding location V21 in the integrated map information M23, and sets a region where there is a high possibility that an obstacle exists.

In addition, it is assumed that a location where there is a high possibility that an obstacle does not exist in the map information M21 of the own device is a location where there is a high possibility that an obstacle exists in the map information M22 of the other device. Also in this case, the integration unit 267 prioritizes the value in the map information M21 of the own device, and associates a value indicating that there is a low possibility that an obstacle exists with a corresponding location V22 in the integrated map information M23, thereby setting a region where there is a low possibility that an obstacle exists.

Note that a value associated with a corresponding location V23 of the integrated map information M23 may be increased for a location where there is a high possibility that an obstacle exists in both the map information M21 of the own device and the map information M22 of the other device.

(4-2. Attenuation of Reliability According to Communication Delay)

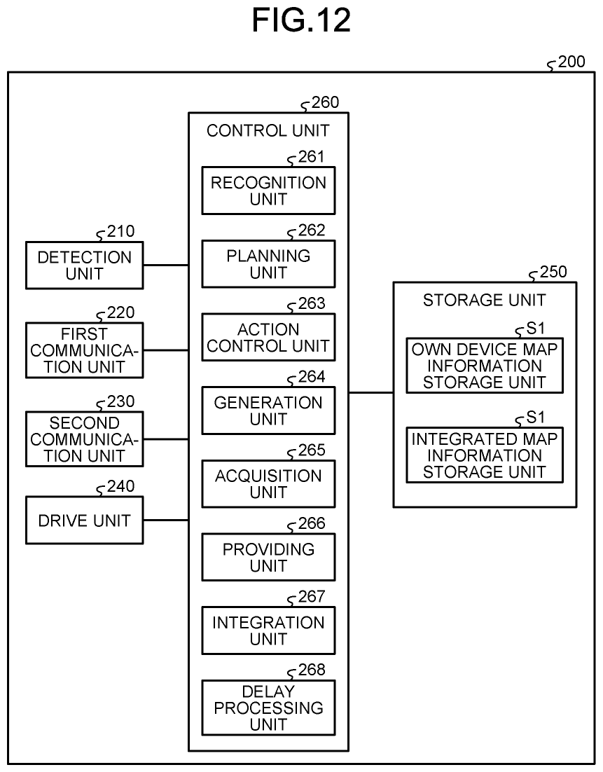

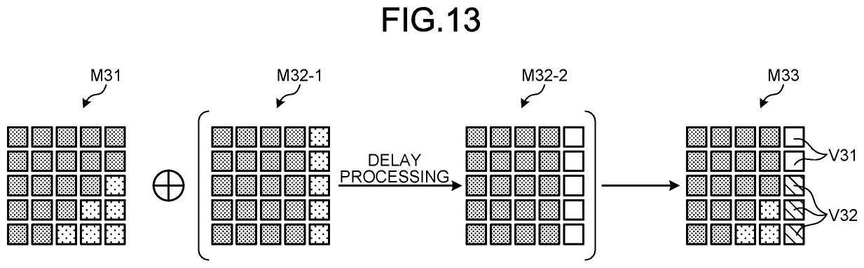

When generating the integrated map information, the mobile body 200 may attenuate the reliability of the map information of other device according to a communication delay with other mobile body. FIG. 12 is a diagram illustrating an example of a functional configuration of a mobile body according to a modified example. FIG. 13 is a diagram illustrating a second modified example of an integration method of map information.

As illustrated in FIG. 12, the mobile body 200 includes a delay processing unit 268 that processes map information of other device by reflecting a delay time from the time of observation including a communication delay. The delay processing unit 268 processes the map information of the other device so as to decrease the first value corresponding to the possibility that the obstacle is present and the second value corresponding to the possibility that the obstacle is not present, and increase the third value corresponding to the possibility that the presence or absence of the obstacle is unknown.

As illustrated in FIG. 13, for example, the integration unit 267 performs delay processing on map information M32-1 of other device, and generates map information M32-2 of the other device in which the first value corresponding to the possibility that an obstacle is present is decreased. The integration unit 267 integrates map information M31 of own device and the map information M32-2 of the other device processed by the delay processing unit 268 to generate integrated map information M33. As a result, values associated with corresponding locations V31 and V32 of the integrated map information M33 are smaller and the reliability indicating the possibility of the presence of an obstacle is lower than when the map information M31 of the own device and the map information M32-1 of the other device are integrated as they are.

(4-3. Provision of Integrated Map Information)

In the above embodiment, the mobile body 200 may provide the integrated map information to other mobile body 200. In this case, metadata indicating from which mobile body 200 the information is associated with each unit element constituting the map information. When generating integrated map information, the mobile body 200 adjusts the first value, the second value, or the third value on the basis of the metadata so that the reliability indicating the possibility of the presence of an obstacle, or the like does not fluctuate each time the integrated map information is generated. For example, in a case where a value based on map information of own device is included in the map information received from other mobile body 200, it is possible to omit adjustment of the value based on the map information of the own device or update the value based on the map information of the own device to a value of the latest map information of the own device.

### 5. Modified Example of Method of Specifying Mobile Body Group

(5-1. Specification by High-Speed Communicable Range)

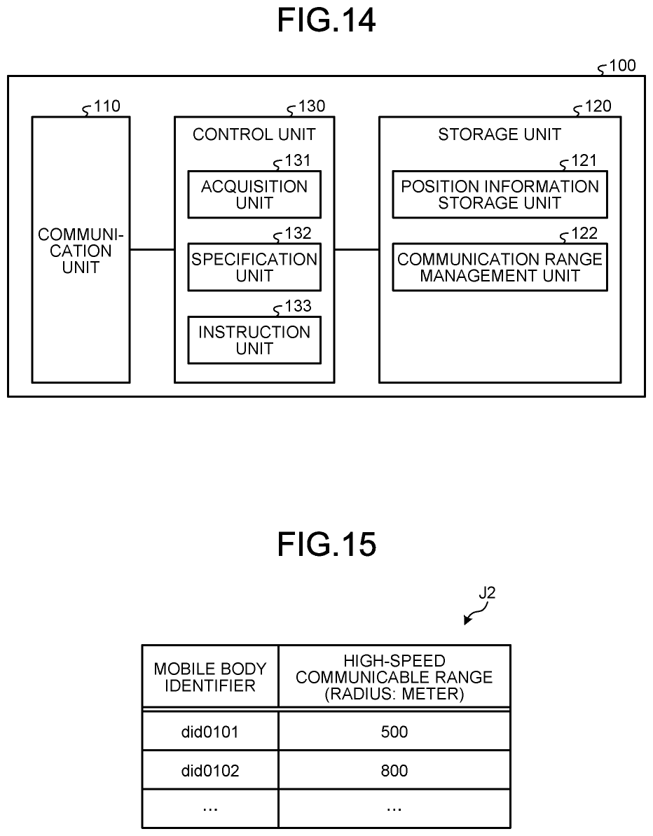

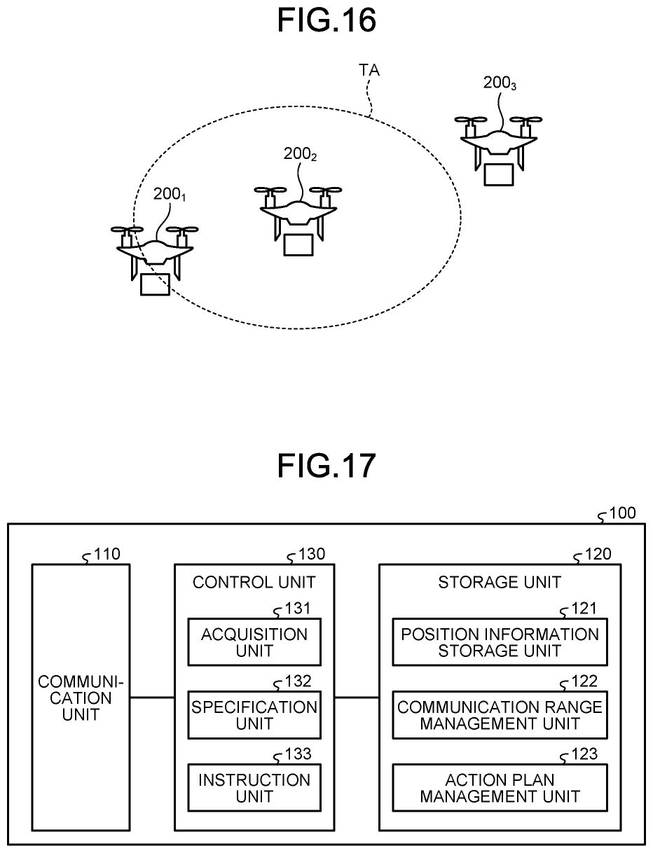

The management device 100 may specify the mobile body group based on a high-speed transmittable/receivable range of the mobile body 200. FIG. 14 is a diagram illustrating an example of a functional configuration of a management device according to a modified example. FIG. 15 is a diagram illustrating an outline of high-speed communicable range information according to a modified example. FIG. 16 is a diagram illustrating an example of a platoon of mobile bodies according to a modified example.

As illustrated in FIG. 14, the storage unit 120 of the management device 100 includes a communication range management unit 122. As illustrated in FIG. 15, high-speed communicable range information J2 stored in the communication range management unit 122 includes an item of a mobile body identifier and an item of a high-speed receivable range, and these items are associated with each other. In the item of the high-speed communicable range, information of a communication radius (meter) of a range in which high-speed data can be transmitted and received by the second communication unit 230 of the mobile body 200 is stored.

The specification unit 132 refers to the position information J1 and the high-speed communicable range information J2 of the mobile body 200, and specifies the mobile body 200₁ and the mobile body 200₂ as a mobile body group when determining that the mobile body 200₁ has entered a high-speed communicable range TA of the mobile body 200₂ as illustrated in FIG. 19.

The instruction unit 133 transmits a notification for instructing the mobile body group specified by the specification unit 132 to start exchanging the map information. For example, the instruction unit 133 transmits a notification instructing transmission of the map information to the mobile body 200₂ having the high-speed communicable range TA.

### 6. Modified Example of Method of Instructing Exchange of Map Information

(6-1. Instruction Based on Action Plan)

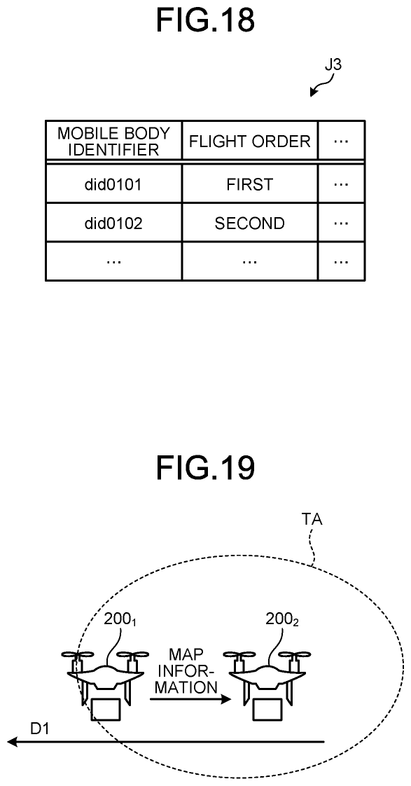

The management device 100 may determine a transmission destination of a notification for instructing to start the exchange of the map information on the basis of an action plan of the mobile body 200. FIG. 17 is a diagram illustrating an example of a functional configuration of a management device according to a modified example. FIG. 18 is a diagram illustrating an outline of high-speed communicable range information according to a modified example. FIG. 19 is a diagram illustrating an example of a platoon of mobile bodies according to a modified example.

As illustrated in FIG. 17, the storage unit 120 of the management device 100 includes an action plan management unit 123. As illustrated in FIG. 18, action plan information J3 stored in the action plan management unit 123 includes items such as an a mobile body identifier and an item of flight order, and these items are associated with each other. In the item of the flight order, information of a predetermined flight order is stored.

The specification unit 132 refers to the position information J1 and the high-speed communicable range information J2 of the mobile body 200. Then, as illustrated in FIG. 19, when determining that the mobile body 200₁ has entered the high-speed communicable range TA of the mobile body 200₂, the specification unit 132 specifies the mobile body 200₁ and the mobile body 200₂ as a mobile body group. Note that the specification unit 132 may specify a moving group by a distance between the mobile bodies 200 regardless of the high-speed communicable range TA.

The instruction unit 133 transmits a notification for instructing the mobile body group specified by the specification unit 132 to start exchanging the map information. For example, the instruction unit 133 refers to the action plan information J3, and transmits a notification instructing transmission of map information to the mobile body 200₁ that is planned to fly ahead of the mobile body 200₂ in a flight direction D1 common to the mobile body group.

In addition, the specification unit 132 may transmit a notification instructing to start the exchange of the map information to the mobile body 200₁ flying first at a position where the mobile body 200₂ is expected to fly, on the basis of a transition in the position information of the mobile bodies 200. In this case, the specification unit 132 estimates that the flight direction of the mobile body 200₂ is the same as the flight direction of the mobile body 200₁, and specifies the mobile body 200₁ and the mobile body 200₂ as a mobile body group in a case where it is determined that the mobile body 200₁ has entered the high-speed communicable range TA of the mobile body 200₂.

(6-2. Instruction Based on Equipment Contents)

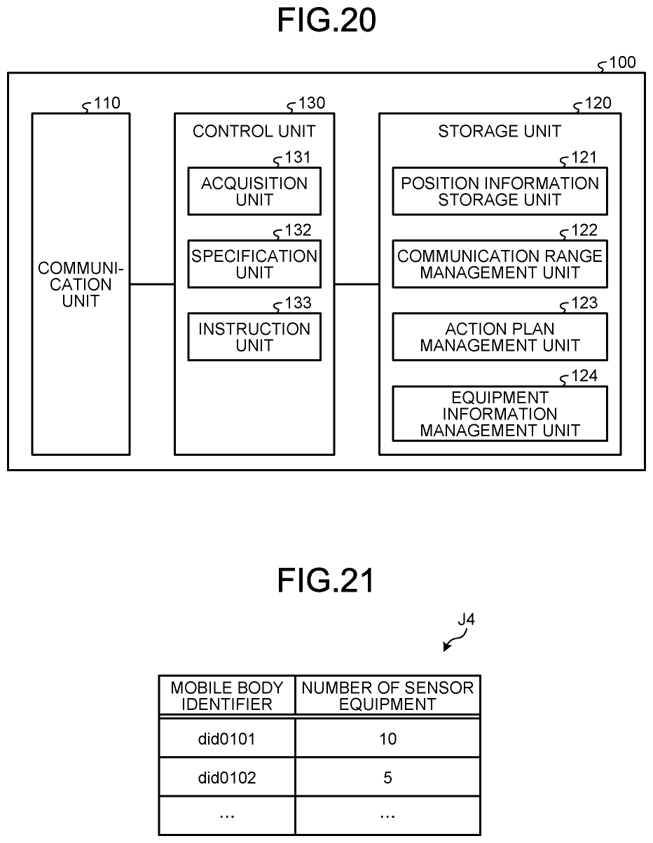

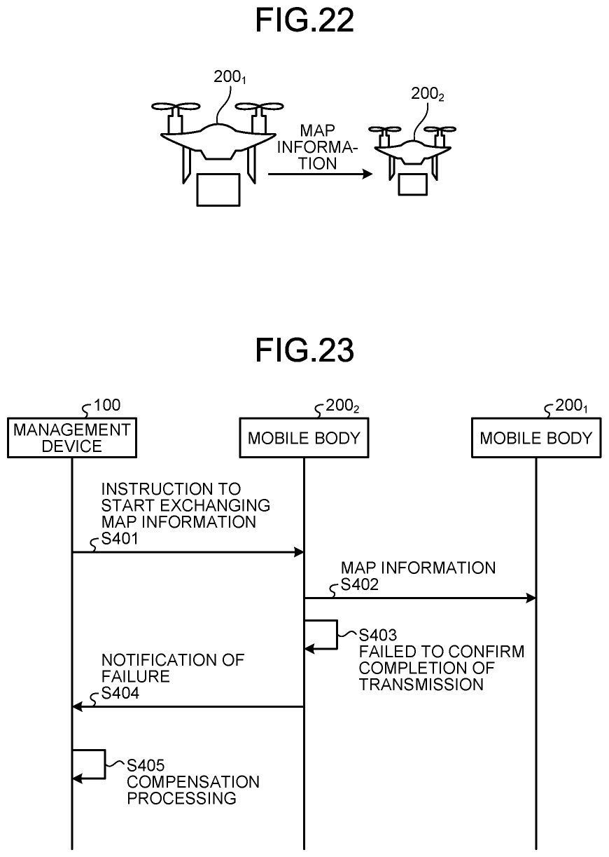

The management device 100 may determine a transmission destination of an instruction to start exchange of the map information on the basis of the content of equipment of the mobile body 200. FIG. 20 is a diagram illustrating an example of a functional configuration of a management device according to a modified example. FIG. 21 is a diagram illustrating an outline of equipment information according to a modified example. FIG. 22 is a diagram illustrating an example of a platoon of mobile bodies according to a modified example.

As illustrated in FIG. 20, the storage unit 120 of the management device 100 includes an equipment information management unit 124. The equipment information management unit 124 manages equipment information in which the number of obstacle sensors equipped in the mobile body 200 is recorded. As illustrated in FIG. 21, equipment information J4 stored in the equipment information management unit 124 includes an item of a mobile body identifier and an item of the number of sensor equipment, and these items are associated with each other. In the item of the number of sensor equipment, information on the equipment number of the obstacle sensors mounted on the mobile body 200 is stored. Examples of the obstacle sensors mounted on the mobile body 200 include various cameras such as a ToF camera, a stereo camera, a monocular camera, an infrared camera, and a depth camera, and surrounding information detection sensors such as an ultrasonic sensor, a radar, a LiDAR, and a sonar.

The specification unit 132 refers to the position information J1 or the high-speed communicable range information J2 of the mobile body 200. Then, the specification unit 132 specifies the mobile body 200₁ and the mobile body 200₂ as a mobile body group on the basis of the distance between the mobile bodies 200 or the high-speed communicable range of the mobile body 200.

The instruction unit 133 transmits a notification for instructing the mobile body group specified by the specification unit 132 to start exchanging the map information. For example, the instruction unit 133 refers to the equipment information J4, and transmits a notification instructing transmission of map information to the mobile body 200₁ having a larger number of mounted equipment than the mobile body 200₂.

### 7. Compensation Processing by Management Device

In the above embodiment, the management device 100 may execute compensation processing in a case where completion of the transmission of the map information cannot be confirmed in the mobile body 200. FIG. 23 is a sequence diagram illustrating an example of processing of a mobile body system according to a modified example. Hereinafter, as an example of processing of a mobile body system 1, a flow of processing in a case where the mobile body 200₂ cannot confirm completion of the transmission of the map information to the mobile body 200₁ will be described.

The management device 100 specifies the mobile body 200₁ and the mobile body 200₂ as a mobile body group, and transmits a notification instructing to start the exchange of the map information to the mobile body 200₂ (Step S401).

The mobile body 200₂ transmits the map information of the own device to the mobile body 200₁ in accordance with an instruction from the management device 100 (Step S402). Then, the mobile body 200₂ detects that the confirmation of the transmission completion of the map information has failed (that the transmission completion cannot be confirmed) on the basis of a predetermined criterion (Step S403). For example, when communication with the mobile body 200₁ times out or when the number of communication retries exceeds a threshold value, the providing unit 266 of the mobile body 200₂ detects that the confirmation of the transmission completion of the map information has failed. Alternatively, the providing unit 266 of the mobile body 200₂ may detect that the confirmation of the transmission completion of the map information has failed on the basis of an increase in noise with respect to communication, reception of a communication rejection notification or a data garbling notification, or the like. When the confirmation of the transmission completion of the map information fails (when the transmission completion cannot be confirmed), the mobile body 200₂ transmits a notification indicating that the provision of the map information has failed to the management device 100 (Step S404).

The management device 100 executes compensation processing in response to the notification that the provision of the map information received from the mobile body 200₂ has failed (Step S405). As the compensation processing executed by the management device 100, for example, specification of another combination of the mobile bodies 200, a vital check of the mobile body 200₁, and the like can be exemplified.

### 8. Modified Example of Mobile Body System

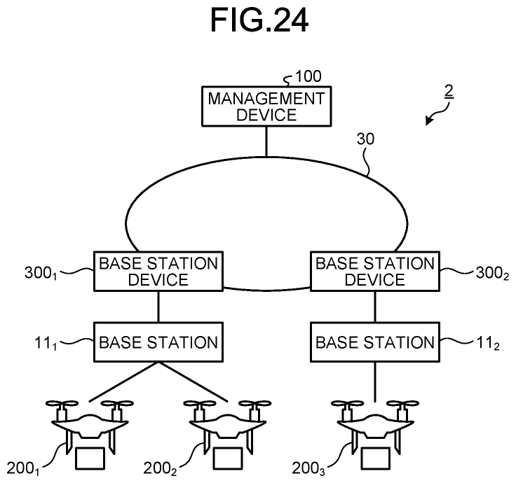

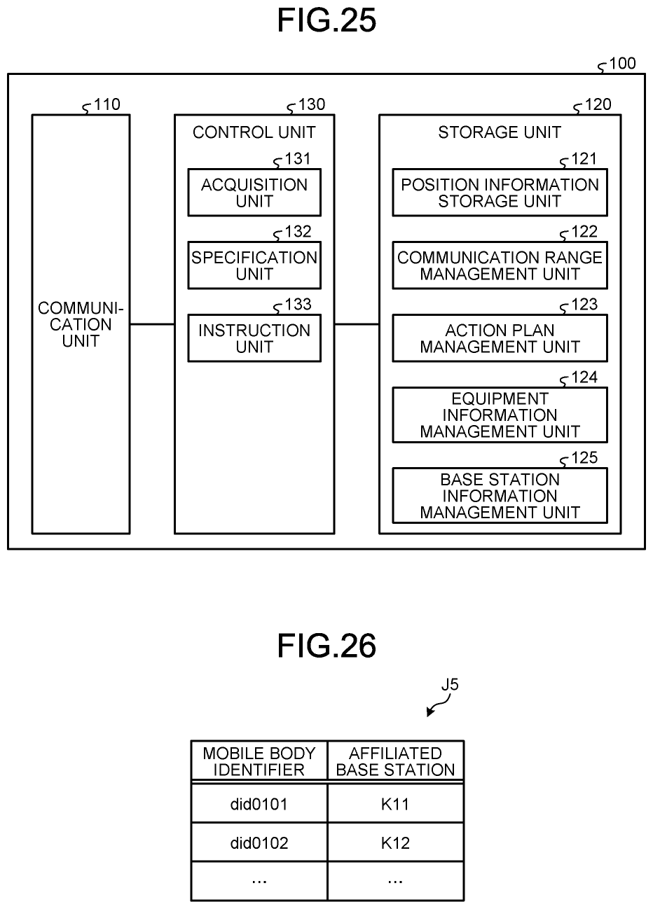

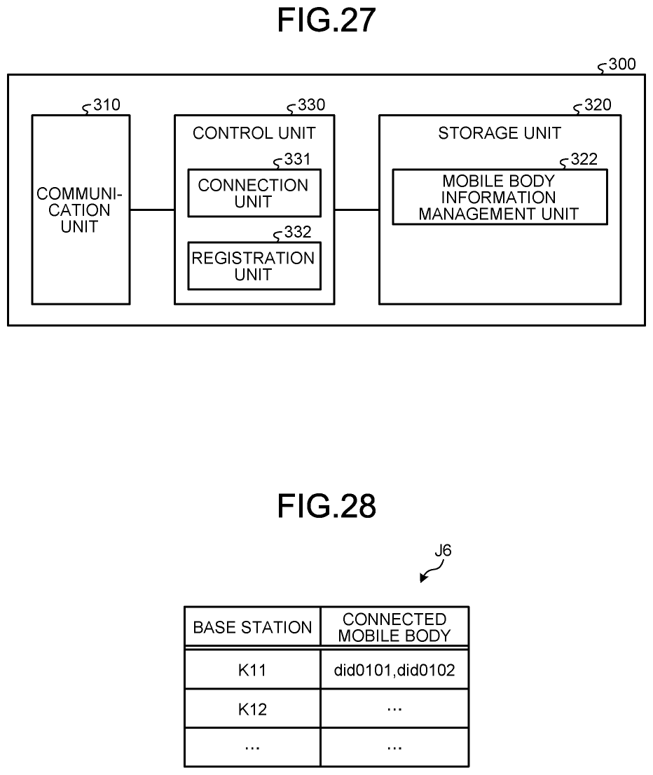

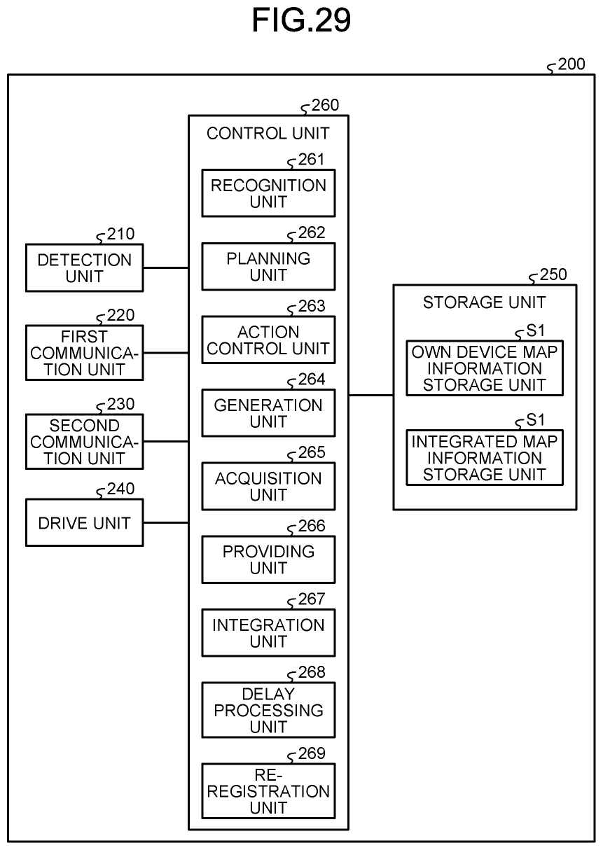

FIG. 24 is a diagram illustrating a configuration example of a mobile body system according to a modified example. FIG. 25 is a diagram illustrating an example of a functional configuration of a management device according to a modified example. FIG. 26 is a diagram illustrating an outline of base station information according to a modified example. FIG. 27 is a diagram illustrating an example of a functional configuration of a base station device according to a modified example. FIG. 28 is a diagram illustrating an outline of mobile body information according to a modified example. FIG. 29 is a diagram illustrating an example of a functional configuration of a mobile body according to a modified example.

In the modified example, a mobile body system 2 is configured using a mobile edge computing or multi-access edge computing (MEC) service of a cellular communication system that is a public wireless network. As illustrated in FIG. 24, in the mobile body system 2 according to the modified example, the management device 100 and the mobile body 200 are connected to a third communication network 30 constructed using the MEC service compatible with the cellular communication system. A base station device 300 that controls a base station 11 is accommodated in the third communication network 30. The management device 100 controls transmission and reception of map information between the mobile bodies 200 via the base station device 300. The mobile body 200 receives an instruction from the management device 100 via the base station device 300 accommodated in the third communication network 30. In addition, the mobile body 200 directly communicates with other mobile body 200 via the base station 11 to the third communication network 30. For example, the mobile body 200₁ and the mobile body 200₂ can directly communicate via a base station 111.

As illustrated in FIG. 25, the storage unit 120 of the management device 100 includes a base station information management unit 125. The base station information management unit 125 stores base station information J5 that is information of the base station 11 to which the mobile body 200 is connected. As illustrated in FIG. 26, the base station information J5 stored in the base station information management unit 125 includes an item of a mobile body identifier and an item of an affiliated base station, and these items are associated with each other. In the item of the affiliated base station, information of the base station 11 to which the mobile body 200 is connected is stored. The base station information J5 is acquired by the acquisition unit 131, for example, and is updated in the latest state.

The specification unit 132 refers to the base station information J5 and specifies the mobile bodies 200 connected to the same base station as a mobile body group. The instruction unit 133 transmits, to the base station device 300, a notification for instructing connection between the mobile bodies 200 connected to the same base station 11 in a state where direct communication is possible.

As illustrated in FIG. 27, the base station device 300 is implemented by an information processing device such as a server, and includes a communication unit 310, a storage unit 320, and a control unit 330.

The communication unit 310 communicates with the management device 100 and the mobile body 200.

The storage unit 320 includes a mobile body information management unit 321. The mobile body information management unit 321 includes an item of a base station and an item of a connected mobile body, and these items are associated with each other. In the item of the base station, information for specifying the base station 11 is stored. In the item of the connected mobile body, a mobile body identifier for specifying the mobile body is stored.

The control unit 330 includes a connection unit 331 and a re-registration unit 332. In accordance with an instruction from the management device 100, the connection unit 331 connects the mobile bodies 200 connected to the same base station 11 in a state in which direct communication is possible via the base station 11. The re-registration unit 332 registers the information of the mobile body 200 connected to the base station 11 in the mobile body information management unit 321.

Note that the base station device 300 may implement a part of the functions of the control unit 130 of the management device 100. For example, the base station device 300 has functions corresponding to the specification unit 132 and the instruction unit 133 of the control unit 130. In this case, the management device 100 periodically transmits a command for instructing the base station device 300 to start exchanging the map information. In response to the command from the management device 100, the base station device 300 specifies the mobile bodies 200 connected to base station device as a mobile body group, and transmits a notification instructing the specified mobile body group to start exchanging the map information. In this manner, a part of the functions of the management device 100 can be distributed to the base station device 300.

The first communication unit 220 of the mobile body 200 communicates with the management device 100 via the base station 11 by a communication scheme compatible with the cellular communication system. In addition, the second communication unit 230 of the mobile body 200 communicates with other mobile body 200 directly connected via the base station 11 by a communication scheme compatible with the cellular communication system.

Furthermore, as illustrated in FIG. 29, the control unit 260 of the mobile body 200 includes a re-registration unit 269 in addition to the configuration according to the above embodiment. When the base station 11 that performs communication is switched by movement, the re-registration unit 269 executes re-registration processing of requesting the base station device 300 that controls the base station 11 of a transfer destination to re-register the own device.

In addition, the above-described embodiments and modified examples can be appropriately combined within a range not contradicting processing contents.

In each of the above embodiments, the base station 11 includes not only a structure having a function as the base station 11 but also a device installed in the structure. The structure is, for example, a building such as a high-rise building, a house, a steel tower, a station facility, an airport facility, a harbor facility, or a stadium. Note that the concept of the structure includes not only a building but also a construction (non-building structure) such as a tunnel, a bridge, a dam, a wall, or an iron pillar, and equipment such as a crane, a gate, or a windmill. In addition, the concept of the structure includes not only a structure on the ground (land) or under the ground but also a structure on water such as a platform or a megafloat, and a structure in water such as a marine observation facility.

Furthermore, the base station 11 may be a base station device configured to be movable. For example, the base station may be a device installed in a mobile body or may be a mobile body itself. The mobile body may be a mobile terminal such as a smartphone. In addition, the mobile body may be a mobile body (for example, a vehicle such as an automobile, a bus, a truck, a train, or a linear motor car) that moves on the ground (land) or a mobile body (for example, the subway) that moves in the ground (for example, in the tunnel) as long as the mobile body is capable of autonomous movement. In addition, the mobile body may be a mobile body (for example, a ship such as a passenger ship, a cargo ship, or a hovercraft) that moves over water or a mobile body (for example, submersibles such as submersible vessels, submarines, and unmanned underwater vehicles) that moves under water. In addition to the drone, the mobile body may be a mobile body (for example, an aircraft such as an airplane or an airship) that moves inside the atmosphere or a mobile body (for example, artificial celestial bodies such as artificial satellites, spacecraft, space stations, and probes) that moves outside the atmosphere.

### 9. Hardware Configuration

(9-1. Configuration Example of Management Device)

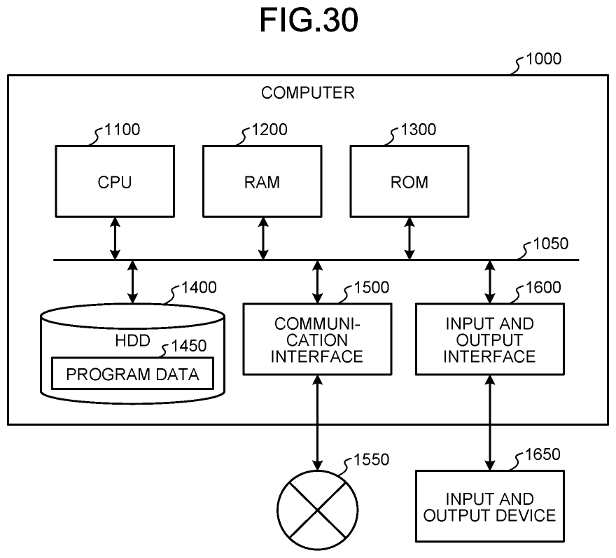

The management device 100 according to the above embodiment is realized by, for example, a computer 1000 having a configuration as illustrated in FIG. 30. Hereinafter, the management device 100 according to the embodiment will be described as an example. FIG. 30 is a hardware configuration diagram illustrating an example of a computer that realizes functions of the management device according to the embodiment.

The computer 1000 illustrated in FIG. 30 includes a CPU 1100, a RAM 1200, a read only memory (ROM) 1300, a hard disk drive (HDD) 1400, a communication interface 1500, and an input and output interface 1600. Each unit of the computer 1000 is connected by a bus 1050.

The CPU 1100 operates on the basis of programs stored in the ROM 1300 or the HDD 1400, and controls each unit. For example, the CPU 1100 develops in the RAM 1200 the programs stored in the ROM 1300 or the HDD 1400, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a recording medium readable by the computer 1000 that non-temporarily records programs executed by the CPU 1100, data used by the programs, and the like. Specifically, the HDD 1400 is a recording medium that records programs for realizing processing functions by the acquisition unit 131, the specification unit 132, and the instruction unit 133 illustrated in FIG. 3, for example.

The communication interface 1500 is an interface for the computer 1000 to connect to an external network 1550 (for example, the Internet). For example, the CPU 1100 receives data from other device or transmits data generated by the CPU 1100 to other device via the communication interface 1500.

The input and output interface 1600 is an interface for connecting an input and output device 1650 and the computer 1000. For example, the CPU 1100 receives data from an input device such as a keyboard and a mouse via the input and output interface 1600. In addition, the CPU 1100 transmits data to an output device such as a display, a speaker, or a printer via the input and output interface 1600. Furthermore, the input and output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the management device 100 according to the embodiment, the CPU 1100 of the computer 1000 executes a program (a program for realizing various processing by the management device 100, and the like) loaded on the RAM 1200. As a result, functions such as various processing executed by the control unit 130 of the management device 100 are realized. In addition, the HDD 1400 stores a program for realizing various processing by the control unit 130 of the management device 100 according to the present disclosure, data stored in the storage unit 120 of the management device 100, and the like. Note that the CPU 1100 reads program data 1450 from the HDD 1400 and executes the program data, but as another example, these programs may be acquired from other device via the external network 1550.

(9-2. Configuration Example of Mobile Body)

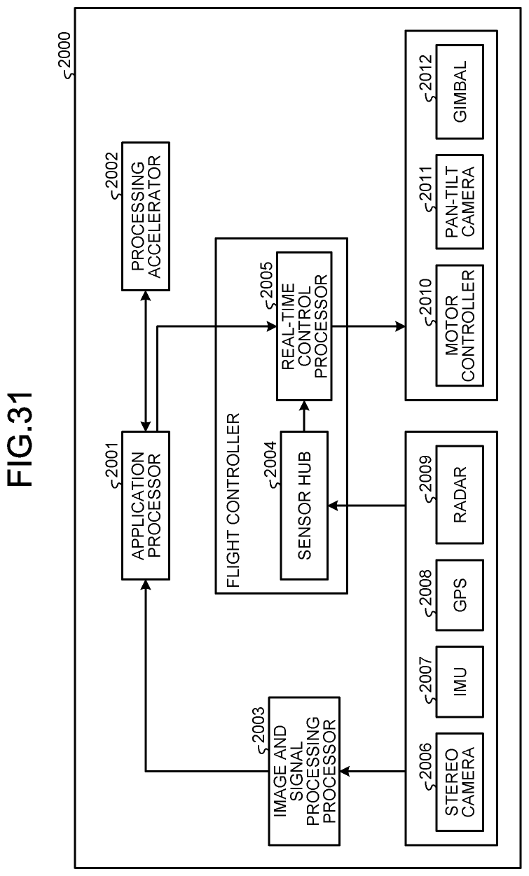

An example of a hardware configuration of the mobile body according to the above embodiment will be described. FIG. 31 is a hardware configuration diagram illustrating an example of a computer that implements functions of the mobile body according to the embodiment;

A computer 2000 illustrated in FIG. 31 includes an application processor 200₁, a processing accelerator 200₂, an image and signal processing processor 2003, a sensor hub 2004, and a real-time processor 2005. The sensor hub 2004 and the real-time processor 2005 function as a flight controller.

In addition, the computer 2000 illustrated in FIG. 31 includes a stereo camera 2006, an IMU 2007, a GPS 2008, a radar 2009, a motor controller 2010, a pan-tilt camera 2011, and a gimbal 2012.

The computer 2000 illustrated in FIG. 31 includes a storage device such as a RAM, a ROM, and an HDD, a communication interface, and the like, in addition to the components illustrated in FIG. 31. Each unit of the computer 2000 is connected by a bus (not illustrated) or the like.

In the computer 2000 illustrated in FIG. 31, functions of various processing executed by the control unit 260 of the mobile body 200 according to the above-described embodiment are realized by at least one of the above-described processors.

### 10. Conclusion

As described above, according to an embodiment of the present disclosure, a mobile body (the mobile body 200 or the like) is a mobile body that autonomously moves in accordance with an instruction from a management device, and includes a generation unit, a first communication unit, a second communication unit, an acquisition unit, a providing unit, and an integration unit. The generation unit generates map information. The first communication unit communicates with the management device. The second communication unit communicates with other mobile body using a communication band different from a communication band used by the first communication unit. The acquisition unit acquires first map information generated in other mobile body through communication by the second communication unit. The providing unit provides the second map information generated by the generation unit to other mobile body through communication by the second communication unit. The integration unit integrates the first map information and the second map information to generate integrated map information. As a result, the mobile body according to the present disclosure can provide the map information of own device to other mobile body in real time, and can realize safe and efficient autonomous movement based on the map information of the own device and other device.

Furthermore, according to an embodiment of the present disclosure, the providing unit specifies other mobile body communicating by the second communication unit through communication with the management device by the first communication unit, and provides the second map information to the specified other mobile body. As a result, exchange of the map information with other mobile body can be started based on the communication with the management device.

Furthermore, according to an embodiment of the present disclosure, the map information is configured by associating the first value, the second value, or the third value with each of unit elements when a detection result of an obstacle is expressed by a cubic data structure. The first value is a value corresponding to a possibility that an obstacle is present, the second value is a value corresponding to a possibility that an obstacle is not present, and the third value is a value corresponding to a possibility that the presence or absence of an obstacle is unknown. When the integration unit integrates the first map information and the second map information, the integration unit adjusts the first value, the second value, or the third value to make the reliability of the second map information relatively higher than that of the first map information. As a result, the mobile body according to the present disclosure can generate the integrated map information that relies on the detection result of the obstacle by the own device.

Furthermore, according to an embodiment of the present disclosure, the map information is configure embodiment of the present disclosure, the map information is configure embodiment of the present disclosure, when integrating the first map information and the second map information, the integration unit gives priority to the first value, the second value, or the third value associated with each unit element of the second map information for each unit element associated with different information between the first map information and the second map information. As a result, the mobile body according to the present disclosure can generate the integrated map information that relies on the detection result of the obstacle by the own device.

Furthermore, according to an embodiment of the present disclosure, the mobile body further includes a delay processing unit that performs processing to reduce the first value and the second value in the first map information and increase the third value by reflecting time from observation caused by a communication delay. As a result, the mobile body according to the present disclosure can increase the reliability of the generated integrated map information.

Furthermore, according to an embodiment of the present disclosure, in a case where the second map information cannot be provided to other mobile body through communication by the second communication unit, the providing unit outputs to the first communication unit a notification of failure in providing the second map information to other mobile body. The first communication unit transmits to the management device the notification of failure in providing the second map information to other mobile body. As a result, the mobile body according to the present disclosure can cause the management device to recognize that the provision of the map information has failed.

Furthermore, according to an embodiment of the present disclosure, the first communication unit communicates with the management device by a communication scheme compatible with a cellular communication system, and the second communication unit communicates with other mobile body by high-speed wireless communication or visible light laser communication. As a result, the mobile body according to the present disclosure can transmit and receive map information having a large data size in real time while properly using the communication with the management device and the communication with other mobile body.

Furthermore, according to an embodiment of the present disclosure, the first communication unit communicates with the management device via a base station by a communication scheme compatible with the cellular communication system. The second communication unit communicates with other mobile body directly connected via a base station by a communication scheme compatible with the cellular communication system. As a result, the mobile body according to the present disclosure can transmit and receive the map information by a communication scheme compatible with the cellular communication system.

Furthermore, according to an embodiment of the present disclosure, the mobile body further includes a re-registration unit that re-registers information of the own device with respect to a base station device installed in a base station as a transfer destination in a case where the base station is transferred by movement. As a result, the mobile body according to the present disclosure can cause a base station as a switching destination to grasp the information of the own device as the base station is switched.

Furthermore, according to an embodiment of the present disclosure, a management device (the management device 100 or the like) includes a communication unit, an acquisition unit, a specification unit, and an instruction unit. The communication unit communicates with the mobile body, and the acquisition unit acquires position information of the mobile body. The specification unit specifies, as a mobile body group, a plurality of the mobile bodies located in a range in which direct communication is possible between the mobile bodies based on the position information acquired by the acquisition unit. The instruction unit instructs the mobile body group specified by the specification unit to exchange the map information. As a result, the management device according to the present disclosure can realize exchange of map information between the mobile bodies located in the range in which direct communication is possible between the mobile bodies.

Furthermore, according to an embodiment of the present disclosure, the management device further includes a communication range management unit that manages information of a high-speed communicable range for each mobile body. When a first mobile body is present in the high-speed communicable range of a second mobile body, the specification unit specifies the first mobile body and the second mobile body as the mobile body group. The instruction unit outputs a notification instructing the second mobile body to start exchanging the map information to the communication unit. The communication unit transmits to the second mobile body the notification instructing start of exchange of the map information. As a result, it is possible to instruct the mobile body group capable of high-speed communication to exchange the map information.

Furthermore, according to an embodiment of the present disclosure, the management device further includes an action plan management unit that manages action plan information in which information of a flight platoon by a plurality of the mobile bodies is recorded. On the basis of the action plan information, the instruction unit outputs, to the communication unit, a notification instructing the mobile body at a head of the flight platoon to start exchanging the map information. The communication unit transmits the notification instructing the mobile body at the head of the flight platoon to start exchanging the map information. As a result, the management device according to the present disclosure can realize efficient exchange of the map information according to the flight platoon.

In addition, according to an embodiment of the present disclosure, the management device further includes an equipment information management unit that manages equipment information in which the number of equipment of obstacle sensors included in the mobile body is recorded. The instruction unit outputs, to the communication unit, a notification instructing a second mobile body equipped with more obstacle sensors than the first mobile body among the mobile bodies in the mobile body group to start exchanging the map information on the basis of the equipment information. The communication unit transmits to the second mobile body the notification instructing start of exchange of the map information. As a result, the management device according to the present disclosure can enhance the contents of the map information in consideration of a difference in sensing capability between the mobile bodies.

Furthermore, according to an embodiment of the present disclosure, the management device further includes a base station information management unit that manages base station information in which a base station to which the mobile body is connected is recorded. The specification unit specifies a plurality of the mobile bodies connected to the same base station as the mobile body group on the basis of the base station information. The instruction unit outputs, to the communication unit, a notification instructing the base station device that controls the base station to which the mobile body group is connected to start exchanging the map information. The communication unit transmits to the base station device the notification instructing start of exchange of the map information. As a result, the management device according to the present disclosure can realize transmission and reception of the map information between the mobile bodies connected to the same base station.

Furthermore, according to an embodiment of the present disclosure, the management device further includes a compensation processing unit that executes compensation processing when receiving a notification from the mobile body that exchange of the map information has failed. As a result, the management device according to the present disclosure can exchange the map information between the mobile bodies as much as possible.

Furthermore, according to an embodiment of the present disclosure, the mobile body system is a mobile body system including a plurality of mobile bodies and a management device. The mobile body includes a generation unit, a first communication unit, a second communication unit, an acquisition unit, a providing unit, and an integration unit. The generation unit generates map information. The first communication unit communicates with the management device. The second communication unit communicates with other mobile body on the basis of an instruction from the management device. The acquisition unit acquires first map information generated in other mobile body through communication by the second communication unit. The providing unit provides second map information generated by the generation unit to other mobile body through communication by the second communication unit. The integration unit integrates the first map information and the second map information to generate integrated map information. The management device further includes a communication range management unit that manages information of a high-speed communicable range for each mobile body. When a first mobile body is present in the high-speed communicable range of a second mobile body, the specification unit specifies the first mobile body and the second mobile body as the mobile body group. The instruction unit outputs a notification instructing the second mobile body to start exchanging the map information to the communication unit. The communication unit transmits to the second mobile body the notification instructing start of exchange of the map information. As a result, the mobile body system according to the present disclosure can realize exchange of the map information between the mobile bodies located in the range in which direct communication is possible between the mobile bodies on the initiative of the management device, and realize safe and efficient autonomous movement based on the map information by the mobile bodies.

Furthermore, the effects described in the present specification are merely illustrative or exemplary, and are not restrictive. That is, the technique according to the present disclosure can exhibit other effects obvious to those skilled in the art from the description of the present specification together with or instead of the above effects.

Note that the present technique can also have configurations below.

(1)

A mobile body that moves autonomously, comprising:

a generation unit that generates map information;

a first communication unit that communicates with a management device;

a second communication unit that communicates with other mobile body using a communication band different from a communication band used by the first communication unit;

an acquisition unit that acquires first map information generated in other mobile body through communication by the second communication unit;

a providing unit that provides second map information generated by the generation unit to other mobile body through communication by the second communication unit; and

an integration unit that integrates the first map information and the second map information to generate integrated map information.

(2)

The mobile body according to (1), wherein

the providing unit specifies other mobile body communicated by the second communication unit through communication with the management device by the first communication unit, and

provides the second map information to the specified other mobile body.

(3)

The mobile body according to (1), wherein

the map information is configured by associating a first value corresponding to a possibility that an obstacle is present, a second value corresponding to a possibility that an obstacle is not present, or a third value corresponding to a possibility that presence or absence of an obstacle is unknown with each unit element when a detection result of the obstacle is expressed by a cubic data structure, and

when integrating the first map information and the second map information, the integration unit adjusts the first value, the second value, or the third value to make reliability of the second map information relatively higher than reliability of the first map information.

(4)

The mobile body according to (3), wherein

when integrating the first map information and the second map information, the integration unit gives priority to the first value, the second value, or the third value associated with each unit element of the second map information for each unit element associated with different information between the first map information and the second map information.

(5)

The mobile body according to (3), further comprising a delay processing unit that performs processing to reduce the first value and the second value in the first map information, and increase the third value by reflecting a delay time from an observation time including a communication delay.

(6)

The mobile body according to (1), wherein

the providing unit outputs, to the first communication unit, a notification that provision of the second map information to other mobile body has failed in a case where completion of transmission of the second map information to other mobile body cannot be confirmed through communication by the second communication unit, and

the first communication unit transmits the notification to the management device.

(7)

The mobile body according to (1), wherein

the first communication unit communicates with the management device by a communication scheme compatible with a cellular communication system, and

the second communication unit communicates with other mobile body by high-speed wireless communication or visible light laser communication.

(8)

The mobile body according to (1), wherein

the first communication unit communicates with the management device via a base station by a communication scheme compatible with a cellular communication system, and

the second communication unit communicates with other mobile body directly connected through a base station by a communication scheme compatible with the cellular communication system.

(9)

The mobile body according to (8), further comprising a re-registration unit that re-registers information of the mobile body with respect to a base station device that controls a base station of a transfer destination in a case where the base station is transferred by movement.

(10)

A mobile body control method for a mobile body that autonomously moves, the mobile body control method comprising:

generating map information;

communicating with a management device;

communicating with other mobile body using a communication band different from a communication band used for communication with the management device;

acquiring first map information generated in other mobile body by communication using a communication band different from a communication band used for communication with the management device;

providing second map information generated by the mobile body to other mobile body by communication using a communication band different from a communication band used for communication with the management device; and

integrating the first map information and the second map information to generate integrated map information.

(11)

A mobile body control program for causing a processor included in a mobile body that moves autonomously to execute:

generating map information;

communicating with a management device;

communicating with other mobile body using a communication band different from a communication band used for communication with the management device;

acquiring first map information generated in other mobile body by communication using a communication band different from a communication band used for communication with the management device;

providing second map information generated by the mobile body to other mobile body by communication using a communication band different from a communication band used for communication with the management device; and

integrating the first map information and the second map information to generate integrated map information.

(12)

A management device that manages autonomous movement of a mobile body, the management device comprising:

a communication unit that communicates with the mobile body;

an acquisition unit that acquires position information of the mobile body;

a specification unit that specifies a plurality of the mobile bodies located in a range in which direct communication is possible between the mobile bodies as a mobile body group based on the position information acquired by the acquisition unit; and

an instruction unit that instructs the mobile body group specified by the specification unit to exchange map information.

(13)

The management device according to (12), further comprising a communication range management unit that manages information of a high-speed communicable range for each mobile body, wherein

the specification unit specifies a first mobile body and a second mobile body as the mobile body group in a case where the first mobile body is present in a high-speed communicable range of the second mobile body,

the instruction unit outputs, to the communication unit, a notification instructing the second mobile body to start exchanging the map information; and

the communication unit transmits the notification to the second mobile body.

(14)

The management device according to (12), further comprising an action plan management unit that manages action plan information in which information of a flight platoon by a plurality of the mobile bodies is recorded, wherein

the instruction unit outputs to the communication unit a notification instructing a mobile body at a head of the flight platoon to start exchange of the map information based on the action plan information, and

the communication unit transmits the notification to the mobile body at the head of the flight platoon.

(15)

The management device according to (12), further comprising an equipment information management unit that manages equipment information in which the number of equipment of obstacle sensors included in the mobile body is recorded, wherein

the instruction unit output to the communication unit a notification instructing a second mobile body equipped with more obstacle sensors than a first mobile body among the mobile bodies of the mobile body group to start exchanging the map information based on the equipment information, and

the communication unit transmits the notification to the second mobile body.

(16)

The management device according to (12), further comprising a base station information management unit that manages base station information in which a base station to which a mobile body is connected is recorded, wherein

the specification unit specifies a plurality of the mobile bodies connected to the same base station as the mobile body group based on the base station information,

the instruction unit outputs to the communication unit a notification instructing a base station device that controls the base station to which the mobile body group is connected to start exchange of the map information, and

the communication unit transmits the notification to the base station device.

(17)

The management device according to (12), further comprising

a compensation processing unit that executes compensation processing when receiving a notification from the mobile body that exchange of the map information has failed.

(18)

A management control method of a management device that manages autonomous movement of a mobile body, the management control method comprising:

communicating with the mobile body;

acquiring position information of the mobile body;

specifying a plurality of the mobile bodies located in a range in which direct communication is possible between the mobile bodies as a mobile body group based on the acquired position information; and

instructing the specified mobile body group to exchange map information.

(19)

A management control program for causing a processor included in a management device that manages autonomous movement of a mobile body to execute:

communicating with the mobile body;

acquiring position information of the mobile body;

specifying a plurality of the mobile bodies located in a range in which direct communication is possible between the mobile bodies as a mobile body group based on the acquired position information; and

instructing the specified mobile body group to exchange map information.

(20)

A mobile body system including a plurality of mobile bodies and a management device, the mobile body system comprising:

a generation unit that generates map information;

a first communication unit that communicates with the management device;

a second communication unit that communicates with other mobile body using a communication band different from a communication band used by the first communication unit;

an acquisition unit that acquires first map information generated in other mobile body through communication by the second communication unit;

a providing unit that provides second map information generated by the generation unit to other mobile body through communication by the second communication unit; and

an integration unit that integrates the first map information and the second map information to generate integrated map information,

wherein the management device includes:

a communication unit that communicates with the mobile body;

an acquisition unit that acquires position information of the mobile body via the communication unit;

a specification unit that specifies a plurality of the mobile bodies located in a range in which direct communication is possible between the mobile bodies as a mobile body group based on the position information acquired by the acquisition unit; and

an instruction unit that instructs the mobile body group specified by the specification unit to exchange the map information.

### REFERENCE SIGNS LIST

1, 2 MOBILE BODY SYSTEM
10 FIRST COMMUNICATION NETWORK
11 BASE STATION
20 SECOND COMMUNICATION NETWORK
30 THIRD COMMUNICATION NETWORK
100 MANAGEMENT DEVICE
110 COMMUNICATION UNIT
120 STORAGE UNIT
121 POSITION INFORMATION STORAGE UNIT
122 COMMUNICATION RANGE MANAGEMENT UNIT
123 ACTION PLAN MANAGEMENT UNIT
124 EQUIPMENT INFORMATION MANAGEMENT UNIT
125 BASE STATION INFORMATION MANAGEMENT UNIT
130 CONTROL UNIT
131 ACQUISITION UNIT
132 SPECIFICATION UNIT
133 INSTRUCTION UNIT
200 MOBILE BODY
210 DETECTION UNIT
220 FIRST COMMUNICATION UNIT
230 SECOND COMMUNICATION UNIT
240 DRIVE UNIT
250 STORAGE UNIT
260 CONTROL UNIT
261 RECOGNITION UNIT
262 PLANNING UNIT
263 ACTION CONTROL UNIT
264 GENERATION UNIT
265 ACQUISITION UNIT
266 PROVIDING UNIT
267 INTEGRATION UNIT
268 DELAY PROCESSING UNIT
269 RE-REGISTRATION UNIT
300 BASE STATION DEVICE
310 COMMUNICATION UNIT
320 STORAGE UNIT
330 CONTROL UNIT

1. A mobile body that moves autonomously, comprising:
a generation unit that generates map information;
a first communication unit that communicates with a management device;
a second communication unit that communicates with other mobile body using a communication band different from a communication band used by the first communication unit;
an acquisition unit that acquires first map information generated in other mobile body through communication by the second communication unit;
a providing unit that provides second map information generated by the generation unit to other mobile body through communication by the second communication unit; and
an integration unit that integrates the first map information and the second map information to generate integrated map information.

2. The mobile body according to claim 1, wherein
the providing unit specifies other mobile body communicated by the second communication unit through communication with the management device by the first communication unit, and
provides the second map information to the specified other mobile body.

3. The mobile body according to claim 1, wherein
the map information is configured by associating a first value corresponding to a possibility that an obstacle is present, a second value corresponding to a possibility that an obstacle is not present, or a third value corresponding to a possibility that presence or absence of an obstacle is unknown with each unit element when a detection result of the obstacle is expressed by a cubic data structure, and
when integrating the first map information and the second map information, the integration unit adjusts the first value, the second value, or the third value to make reliability of the second map information relatively higher than reliability of the first map information.

4. The mobile body according to claim 3, wherein
when integrating the first map information and the second map information, the integration unit gives priority to the first value, the second value, or the third value associated with each unit element of the second map information for each unit element associated with different information between the first map information and the second map information.

5. The mobile body according to claim 3, further comprising a delay processing unit that performs processing to reduce the first value and the second value in the first map information, and increase the third value by reflecting a delay time from an observation time including a communication delay.

6. The mobile body according to claim 1, wherein
the providing unit outputs, to the first communication unit, a notification that provision of the second map information to other mobile body has failed in a case where completion of transmission of the second map information to other mobile body cannot be confirmed through communication by the second communication unit, and
the first communication unit transmits the notification to the management device.

7. The mobile body according to claim 1, wherein
the first communication unit communicates with the management device by a communication scheme compatible with a cellular communication system, and
the second communication unit communicates with other mobile body by high-speed wireless communication or visible light laser communication.

8. The mobile body according to claim 1, wherein
the first communication unit communicates with the management device via a base station by a communication scheme compatible with a cellular communication system, and
the second communication unit communicates with other mobile body directly connected through a base station by a communication scheme compatible with the cellular communication system.

9. The mobile body according to claim 8, further comprising a re-registration unit that re-registers information of the mobile body with respect to a base station device that controls a base station of a transfer destination in a case where the base station is transferred by movement.

10. A mobile body control method for a mobile body that autonomously moves, the mobile body control method comprising:
generating map information;
communicating with a management device;
communicating with other mobile body using a communication band different from a communication band used for communication with the management device;
acquiring first map information generated in other mobile body by communication using a communication band different from a communication band used for communication with the management device;
providing second map information generated by the mobile body to other mobile body by communication using a communication band different from a communication band used for communication with the management device; and
integrating the first map information and the second map information to generate integrated map information.

11. A mobile body control program for causing a processor included in a mobile body that moves autonomously to execute:
generating map information;
communicating with a management device;
communicating with other mobile body using a communication band different from a communication band used for communication with the management device;
acquiring first map information generated in other mobile body by communication using a communication band different from a communication band used for communication with the management device;
providing second map information generated by the mobile body to other mobile body by communication using a communication band different from a communication band used for communication with the management device; and
integrating the first map information and the second map information to generate integrated map information.

12. A management device that manages autonomous movement of a mobile body, the management device comprising:
a communication unit that communicates with the mobile body;
an acquisition unit that acquires position information of the mobile body;
a specification unit that specifies a plurality of the mobile bodies located in a range in which direct communication is possible between the mobile bodies as a mobile body group based on the position information acquired by the acquisition unit; and
an instruction unit that instructs the mobile body group specified by the specification unit to exchange map information.

13. The management device according to claim 12, further comprising a communication range management unit that manages information of a high-speed communicable range for each mobile body, wherein
the specification unit specifies a first mobile body and a second mobile body as the mobile body group in a case where the first mobile body is present in a high-speed communicable range of the second mobile body,
the instruction unit outputs, to the communication unit, a notification instructing the second mobile body to start exchanging the map information; and
the communication unit transmits the notification to the second mobile body.

14. The management device according to claim 12, further comprising an action plan management unit that manages action plan information in which information of a flight platoon by a plurality of the mobile bodies is recorded, wherein
the instruction unit outputs to the communication unit a notification instructing a mobile body at a head of the flight platoon to start exchange of the map information based on the action plan information, and
the communication unit transmits the notification to the mobile body at the head of the flight platoon.

15. The management device according to claim 12, further comprising an equipment information management unit that manages equipment information in which the number of equipment of obstacle sensors included in the mobile body is recorded, wherein
the instruction unit output to the communication unit a notification instructing a second mobile body equipped with more obstacle sensors than a first mobile body among the mobile bodies of the mobile body group to start exchanging the map information based on the equipment information, and
the communication unit transmits the notification to the second mobile body.

16. The management device according to claim 12, further comprising a base station information management unit that manages base station information in which a base station to which a mobile body is connected is recorded, wherein
the specification unit specifies a plurality of the mobile bodies connected to the same base station as the mobile body group based on the base station information,
the instruction unit outputs to the communication unit a notification instructing a base station device that controls the base station to which the mobile body group is connected to start exchange of the map information, and
the communication unit transmits the notification to the base station device.

17. The management device according to claim 12, further comprising
a compensation processing unit that executes compensation processing when receiving a notification from the mobile body that exchange of the map information has failed.

18. A management control method of a management device that manages autonomous movement of a mobile body, the management control method comprising:
communicating with the mobile body;
acquiring position information of the mobile body;
specifying a plurality of the mobile bodies located in a range in which direct communication is possible between the mobile bodies as a mobile body group based on the acquired position information; and
instructing the specified mobile body group to exchange map information.

19. A management control program for causing a processor included in a management device that manages autonomous movement of a mobile body to execute:
communicating with the mobile body;
acquiring position information of the mobile body;
specifying a plurality of the mobile bodies located in a range in which direct communication is possible between the mobile bodies as a mobile body group based on the acquired position information; and
instructing the specified mobile body group to exchange map information.

20. A mobile body system including a plurality of mobile bodies and a management device, the mobile body system comprising:
a generation unit that generates map information;
a first communication unit that communicates with the management device;
a second communication unit that communicates with other mobile body using a communication band different from a communication band used by the first communication unit;
an acquisition unit that acquires first map information generated in other mobile body through communication by the second communication unit;
a providing unit that provides second map information generated by the generation unit to other mobile body through communication by the second communication unit; and
an integration unit that integrates the first map information and the second map information to generate integrated map information,
wherein the management device includes:
a communication unit that communicates with the mobile body;
an acquisition unit that acquires position information of the mobile body via the communication unit;
a specification unit that specifies a plurality of the mobile bodies located in a range in which direct communication is possible between the mobile bodies as a mobile body group based on the position information acquired by the acquisition unit; and
an instruction unit that instructs the mobile body group specified by the specification unit to exchange the map information.
